(19) United States
(12) Patent Application Publication
(10) Pub. No.: US 2008/0303903 A1
(43) Pub. Date: Dec. 11, 2008

(54) Networked video surveillance system

(75) Inventors: Sheldon R. Bentley, Palo Alto, CA (US); Stephen D. Bristow, Los Altos Hills, CA (US); Bruce Eric Durham, Marlborough, MA (US); James O. Achugbue, San Luis Obispo, CA (US); Gregory M. Rayzman, Palo Alto, CA (US)

Correspondence Address: PATENT LAW OFFICE OF DAVID G. BECK, P. O. BOX 1146, MILL VALLEY, CA, 94942, US

(73) Assignee: Connexed Technologies Inc., Palo Alto, CA (US)

(21) Appl. No.: 12/221,579

(22) Filed: Aug. 5, 2008

Related U.S. Application Data
(63) Continuation-in-part of application No. 10/990,720, filed on Nov. 17, 2004.
(60) Provisional application No. 60/526,121, filed on Dec. 2, 2003.

(51) Int. Cl. H04N 7/18

(52) U.S. Cl. 348/143; 348/E07.085

(57) ABSTRACT

A method of storing and accessing surveillance camera video data is provided. Captured video data as well as corresponding metadata is stored, at least temporarily, at the user sites. Additionally, the metadata and at least a portion of the video data is transmitted to a remotely located third party site where it is stored. The user server systems located at the independent user sites are connected to the third party server system via the Internet. Parties having data access rights, i.e., validated users, access the data stored at the third party site using Internet connected secondary computer systems.

### CROSS-REFERENCES TO RELATED APPLICATIONS

This application is a continuation-in-part of U.S. patent application Ser. No. 10/990,720, filed Nov. 17, 2004, which claims the benefit of U.S. Provisional Patent Application Ser. No. 60/526,121, filed Dec. 2, 2003, the disclosures of which are incorporated herein by reference for any and all purposes.

### FIELD OF THE INVENTION

The present invention relates generally to surveillance systems and, more particularly, to a method and apparatus for remotely storing and analyzing surveillance camera video data.

### BACKGROUND OF THE INVENTION

Due to the increased belief by businesses and individuals alike that a burglar alarm system is a necessity, considerable time and effort has been placed on the development of a variety of different types of security systems. One of the most common types of security systems employ simple trip switches to detect intruders. The switches range from door and window switches to relatively sophisticated motion detectors employing IR, ultrasonic and other means to detect motion in their field of view. These systems typically include a simple means of arming/disarming the system, e.g., a key or keypad, and a horn, bell or similar means that alerts people in the vicinity of the alarm while hopefully frightening the intruder away.

In order to eliminate the dependence on other people reporting to police a ringing alarm, newer security systems use alarm monitoring companies to monitor the status of their alarms and report possible security breaches to the authorities. Typically the on-premises alarm system is coupled to the central monitoring company by phone lines. When the on-premises alarm detects a possible security breach, for example due to the tripping of a door switch or detection by a motion detector, it automatically dials up the monitoring company and reports its status. Depending upon system sophistication, it may also report which alarm switch was activated. A human operator then follows the monitoring company's procedures, for example first calling the owner of the alarm system to determine if the alarm was accidentally tripped. If the operator is unable to verify that the alarm was accidentally tripped, they typically call the local authorities and report the possible breach. Recent versions of this type of security system may also have RF capabilities, thus allowing the system to report status even if the phone lines are inoperable. These security systems also typically employ back-up batteries in case of a power outage.

Properties requiring greater security, such as banks or commercial retail stores in which petty theft is common, often augment or replace traditional security systems with surveillance camera systems. The video images acquired by the surveillance cameras are typically recorded on-site, for example using either magnetic tape recorders (e.g., VCRs) or digital recorders (e.g., DVD and DVR recorders). In addition to recording the output from the surveillance cameras, high end video-based security systems employ security personnel to monitor the camera output 24 hours a day, 7 days a week. Lower end video-based security systems typically do not utilize real-time camera monitoring, instead reviewing the recorded camera output after the occurrence of a suspected security breach. As the video data in either of these systems is typically archived on-premises, the data is subject to accidental or intentional damage, for example due to on-site fire, tampering, etc.

Typical prior art video-based security systems capture images without regard to content. Furthermore the video data, once recorded, is simply archived. If the data must be reviewed, for example to try and determine how and when a thief may have entered the premises in question, the recorded video data must be painstakingly reviewed, minute by minute. Often times the clue that went unnoticed initially continues to elude the data reviewers, in part due to the amount of imagery that the reviewer must review to find the item of interest which may last for no more than a minute.

The advent of the Internet and low priced digital surveillance cameras has lead to a new form of video surveillance, typified by the “nanny cam” system. The user of such a system couples one or more digital surveillance cameras to an Internet connected computer and then, when desired, uses a second Internet connected computer to monitor the output from the surveillance cameras. Although such systems offer little protection from common theft as they require continuous monitoring, they have been found to be quite useful for people who wish to periodically visually check on the status of a family member.

Although a variety of video-based security systems have been designed, these systems typically are limited in their data handling capabilities. Accordingly, what is needed in the art is a video-based security system in which captured video images can be remotely analyzed and stored. The present invention provides such a system.

### SUMMARY OF THE INVENTION

The present invention provides a method of storing and accessing video data from surveillance cameras, the surveillance cameras typically located at multiple, independent user sites. Captured video data as well as corresponding metadata is stored, at least temporarily, at the user sites. Additionally, the metadata and at least a portion of the video data is transmitted to a remotely located third party site where it is stored. The user server systems located at the independent user sites are connected to the third party server system via the Internet. Parties having data access rights, i.e., validated users, access the data stored at the third party site using Internet connected secondary computer systems.

In one aspect of the invention, each user server system includes a firewall that is configured such that it will not accept inbound connections.

In another aspect of the invention, each user server system periodically transmits a query, also referred to herein as a heart beat, to the third party server system. The query serves as a status check, verifying that a specific user server system is operational and on-line. By performing a system self-check prior to transmitting the query, the query can also be used to communicate user system health to the third party server system. The query is also used as a preferred means for a user server system to check for the availability of operating system, application software and configuration updates.

In another aspect of the invention, each user server system requests and downloads updates from the third party server system, the updates including operating system updates, application software updates, and configuration updates.

In another aspect of the invention, prior to transmitting video data to the third party server system, the user server system compresses and/or filters and/or augments and/or prioritizes the video data. User server systems can also vary video data transmission parameters in response to variations in the bandwidth of the server system Internet link.

A further understanding of the nature and advantages of the present invention may be realized by reference to the remaining portions of the specification and the drawings.

### BRIEF DESCRIPTION OF THE DRAWINGS

FIG. 1 is an illustration of a video surveillance system according to the prior art;

FIG. 2 is an illustration of a second prior art video surveillance system utilizing the Internet to provide the user with access to camera data;

FIG. 3 is an illustration of a preferred embodiment of the invention utilizing a third party video data storage and handling site;

FIG. 4 is an illustration of an exemplary data screen that allows a user to assign data storage periods for each camera;

FIG. 5 is an illustration of an alternate embodiment of the invention;

FIG. 6 is an illustration of an embodiment of the invention utilizing an on-site data system;

FIG. 7 is an illustration of a graphical activity timeline screen;

FIG. 8 is an illustration of a screen containing multiple camera fields of view;

FIG. 9 is an illustration of a camera's field of view divided into three zones;

FIG. 10 is an illustration of a geochronshape rule data entry screen;

FIG. 11 is an illustration of a geochronshape rule data entry screen that includes auto-zoom features;

FIG. 12 is an illustration of a geochronshape rule data entry screen that includes auto-focus features;

FIG. 13 is an illustration of a screen containing multiple camera fields of view and auto-flagging features;

FIG. 14 is an illustration of an action overview screen;

FIG. 15 is an illustration of an action log screen;

FIG. 16 is an illustration of an alternate embodiment of the invention that provides multiple means of user notification as well as user interrogation features; and

FIG. 17 is an illustration of a notification rule data entry screen.

### DESCRIPTION OF THE SPECIFIC EMBODIMENTS

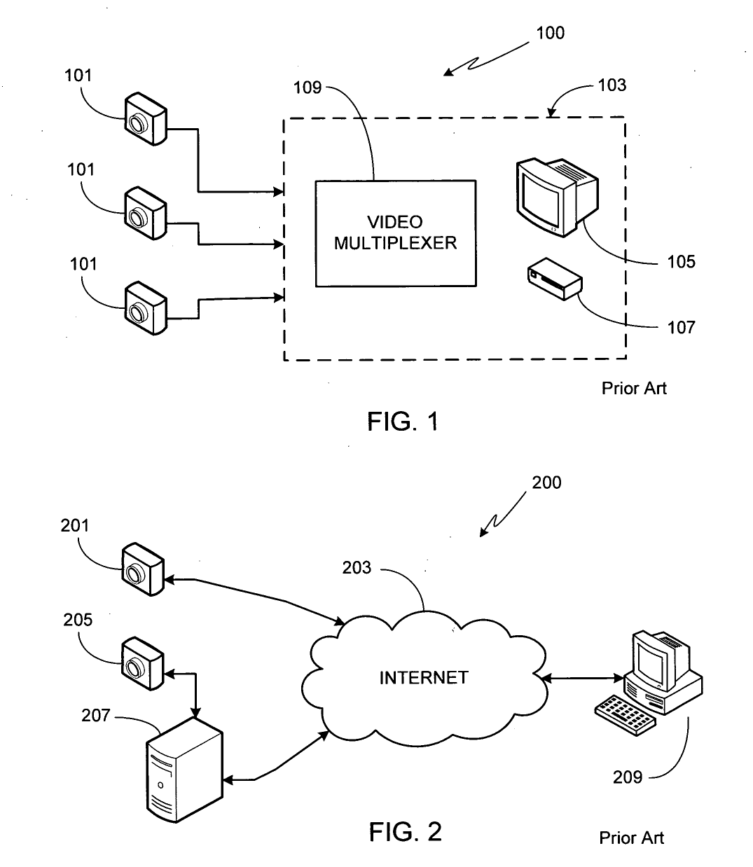

FIG. 1 is an illustration of a prior art video surveillance system 100 often used in stores, banks and other businesses. The system includes at least one, and preferably multiple, cameras 101. The output from each camera 101 is sent, typically via hard wire, to a monitoring/data base system 103. Monitoring/data base system 103 includes at least one monitor 105 and at least one data base system 107. Data base system 107 typically uses either a video cassette recorder (VCR) or a CD/DVD recorder, both recorders offering the ability to store the data acquired by cameras 101 on a removable medium (i.e., tape or disc). Monitoring/data base system 103 may also include one or more video multiplexers 109, thus allowing the data (images) captured by cameras 101 to be shown on fewer monitors 105 and/or recorded on fewer recorders 107. Depending upon the requirements placed on surveillance system 100 by its users, the data acquired by cameras 101 may be under continual scrutiny, for example by one or more security personnel viewing monitor 105, or only reviewed when necessary, for example after the occurrence of a robbery or other security breaching event.

FIG. 2 is an illustration of a second prior art video surveillance system 200 utilizing the Internet to provide the user with access to camera data. The system includes one or more cameras. In one instance the cameras (e.g., camera 201) have the ability to directly connect to Internet 203, for example via a standard phone line or DSL line or with a wireless link. Alternately, the cameras (e.g., camera 205) can be coupled to a computer 207 or other means that can format (e.g., digitize, compress, etc.) the output of camera 205 and then transmit the formatted camera output over Internet 203. The user is able to retrieve, view and store the output from cameras 201 and/or 205 by linking a computer 209 to Internet 203. Computer 209 may use either an internal or external modem or Ethernet adaptor to link to Internet 203. The acquired camera video is stored on an internal hard drive, an external hard drive or removable media associated with computer 209. As computer 209 is required to retrieve the video data from cameras 201 and/or 205, it must remain on and connected to Internet 203 whenever camera data storage is desired.

### System Configuration

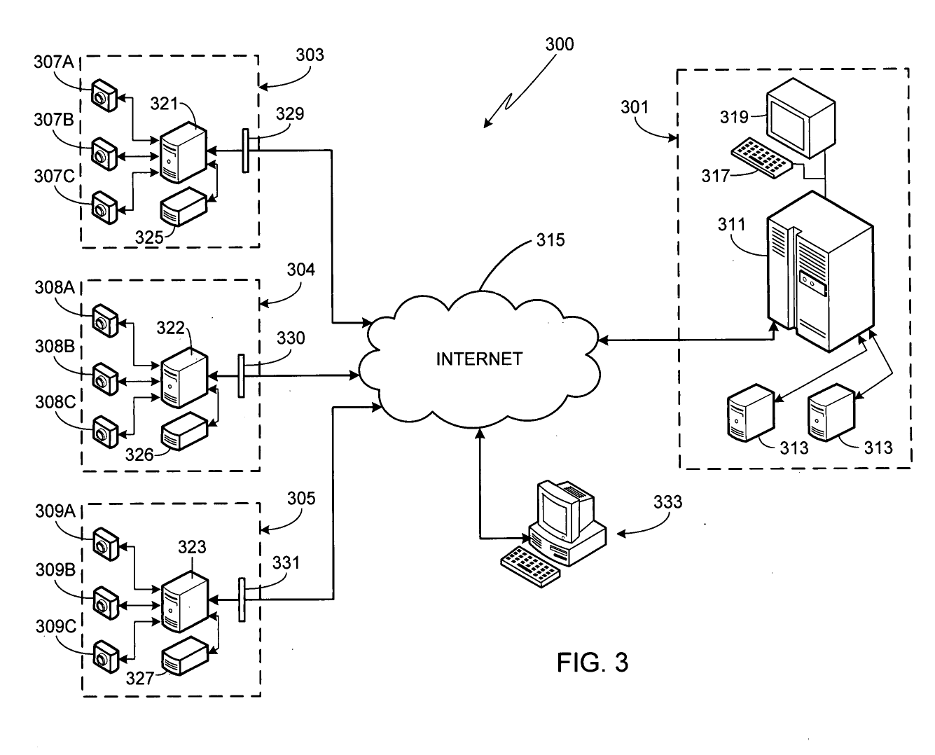

FIG. 3 illustrates a preferred embodiment 300 of the invention. This embodiment, as with other embodiments of the invention, utilizes a third party site 301 to store and handle the video data acquired by one or more system users. In the exemplary embodiment, three system users 303-305 are shown coupled to the third party site via Internet 315, although it will be appreciated that either fewer or greater numbers of users can be coupled to the third party site, and that the system users can be unrelated or affiliated, for example multiple sites of a single company.

Third party site 301 is remotely located from the users, thus eliminating the need for permanent on-site storage by providing each of the users with a safe, off-site video data storage location. Since site 301 is under third party control and is located off-premises, the risk of an accident (e.g., fire) or an intentional act (e.g., tampering by a disgruntled employee) from damaging or destroying the stored data is greatly reduced. Additionally, as site 301 is a dedicated storage/handling site, redundant storage systems can be used as well as more advanced data manipulation systems, all at a fraction of the cost that a single user would incur to achieve the same capabilities.

At each user site, one or more video surveillance cameras are included. In the exemplary embodiment shown in FIG. 3, cameras 307A-307C are located at site 303, cameras 308A-308C are located at site 304, and cameras 309A-309C are located at site 305. The number of cameras located at each site are typically based on (i) the size of the site, (ii) the level of desired surveillance, (iii) the complexity of the site (e.g., a single manufacturing floor versus a floor divided into multiple rooms with multiple access points), (iv) the value of the property under surveillance, (v) the number of access points (e.g., windows, doors, skylights, etc.), (vi) system and installation cost, etc., although it will be appreciated that other factors may be considered in determining the number of cameras required to properly monitor a particular site.

Third party site 301 includes at least one server computer 311, also referred to as simply a server, and one or more storage devices 313. Server(s) 311 is used to process the video data received via Internet 315 from users 303-305 as described more fully below. Additionally, server(s) 311 controls the user interface to the system as described more fully below. Preferably server(s) 311 also performs the functions of overall system maintenance, individual user system maintenance, camera management, billing/accounting, etc. The required applications can be drafted using Java, C++ or other language and written to work in an operating system environment such as that provided by the Linux, Unix, or Windows operating systems. The applications can use middleware and back-end services such as those provided by data base vendors such as Oracle or Microsoft.

Storage devices 313 can utilize removable or non-removable medium or a combination thereof. Suitable storage devices 313 include, but are not limited to, disks/disk drives, disk drive cluster(s), redundant array of independent drives (RAID), or other means.

Third party site also includes means for downloading applications, updating applications, inputting instructions, reviewing data, reviewing and/or revising user accounts, etc. These means can either be local, for example a keyboard 317 and a monitor 319 directly coupled to server(s) 311 as shown, or these means can be remotely located and securely connected to server(s) 311, for example using a remote computer system (not shown) securely linked to server(s) 311 via Internet 315.

If desired, one or more additional third party sites, not shown, can be coupled to the first third party site 301 via Internet 315. Preferably additional third party sites are geographically located at some distance from the first third party site 301, thus providing system redundancy at a location that is unlikely to be affected by any system disturbance (e.g., power outage, natural disaster, etc.) affecting site 301. The additional third party sites can be used for remotely reviewing/revising applications and data as previously noted, or for providing redundant data storage.

In the preferred embodiment of the invention illustrated in FIG. 3, each user location includes at least one user server, e.g., servers 321-323. Associated with each user server is one or more user storage devices, e.g., memories 325-327. Although shown as external storage devices, it will be appreciated that storage devices 325-327 may be integrated within the user servers, i.e., mounted within the same enclosures. Suitable storage devices 325-327 include, but are not limited to, disks/disk drives, disk drive cluster(s), redundant array of independent drives (RAID), or other means.

In the preferred embodiment, the user servers (e.g., servers 321-323) provide control over the video cameras associated with a particular user site. For example, and as described more fully below, the user servers are preferably used to control the operation of the individual cameras (e.g., camera movement, resolution, auto-zoom features, auto-focus features, etc.), video data transmission instructions (e.g., data transmission frequency, data compression characteristics, communication protocols, etc.), camera prioritization, etc. Preferably these and other user site specific instructions are downloaded from third party site 301 to the individual user servers (e.g., user servers 321-323). Additionally, and as illustrated, preferably data input means such as a keyboard are not attached to the user servers, thus further limiting the possibility of non-authorized personnel from tampering with the security systems.

Data Handling

In the embodiment of FIG. 3, data acquired from the cameras is transmitted to the user servers (e.g., servers 321-323) which, in turn, records the data in local memory (e.g., storage devices 325-327). Based on the communication instructions for the system in general, and the communication instructions for the user system in question in particular, data is then sent from the individual user servers to the third party server 311 for recording in the third party site storage devices 313.

Preferably data compression is used to minimize the required storage area on the storage devices (e.g., local storage devices 325-327, third party storage device 313). Additionally, data compression can be used to simplify data transmission between the local user sites (e.g., users 303-305) and third party site 301. Accordingly, a portion of, or all of, the data compression can be performed prior to transmitting the data from a user to the third party site via the Internet. For example, data compression can be performed by the user server (e.g., servers 321-323). A benefit of such an approach is that it allows either more images per second to be uploaded to site 301 over a fixed bandwidth connection or a lower bandwidth connection to be used for a given frame per second rate. Alternately, or in addition to such pre-transmission compression, server 311 can be used to filter and compress the captured video data. In at least one preferred embodiment, server 311 compresses the video data after it has been augmented (e.g., text comments added to specific data frames), manipulated (e.g., combining multiple camera feeds into a single data stream), prioritized (e.g., organized by date, importance, etc.) or otherwise altered. The degree of data compression can vary, for example depending upon the importance attributed to a particular portion of video data or the resolution of the acquired data. Importance can be determined based on camera location, time of day, event (e.g., unusual activity) or other basis. Data compression can utilize any of a variety of techniques, although preferably an industry standardized technique is used (e.g., JPEG, MPEG, etc.).

The data generated by a user system is of one of two types; metadata and video data. Metadata can include, but is not limited to, user account identification, user group or user location (e.g., store ‘x’), camera identification (e.g., camera ‘4’), camera location (e.g., ‘warehouse entrance’), camera grouping (e.g., window cameras, vault cameras, etc.), camera priority, date and time. The date and time information is obtained by the user server from an Internet time authority via NTP (Network Time Protocol), and thus cannot be changed by the user or someone tampering with the user's security system. Video data is comprised of the data acquired by each camera. Note that in addition to recording metadata and video data, third party site 301 can also record the date and time that the data was transferred from the user server to the third party site.

As the video data captured by the user's cameras is transmitted over Internet 315 to third party site 301, the amount of data that can be transferred is dependent upon the available bandwidth of the transmission link. Additionally, in at least one business model the users are charged, at least in part, based on the quantity of data stored at the third party site. Accordingly, in the preferred embodiment a variety of techniques are used to optimize both data transmission and third party data storage. In one such technique, user cameras are divided into ‘traffic’ cameras and ‘security’ cameras. Traffic cameras capture low priority data, for example exterior views of a loading dock. Security cameras capture high priority data, for example the teller cages at a bank. Although the metadata from both the traffic and security cameras is transmitted to the third party site, in one approach only the video data from the security cameras is transmitted to the third party site in accordance with the predefined data transmission rules (e.g., camera priority, data transmission frequency, etc.) while the data acquired by the traffic cameras is maintained in the local user storage device (e.g., devices 325-327). Preferably the local user storage device utilizes a rolling buffer approach to insure that memory is always available. In such a scenario, the captured video data that is maintained within a local storage device (e.g., devices 325-327) is available to the user upon user request, assuming that the requested data is still in local memory. Whether or not the requested data is available, i.e., still in memory, depends on the length of time between the time of data acquisition and the request, the priority assigned to the data/camera, the size of the storage device, and the amount of data that is maintained within the local storage device.

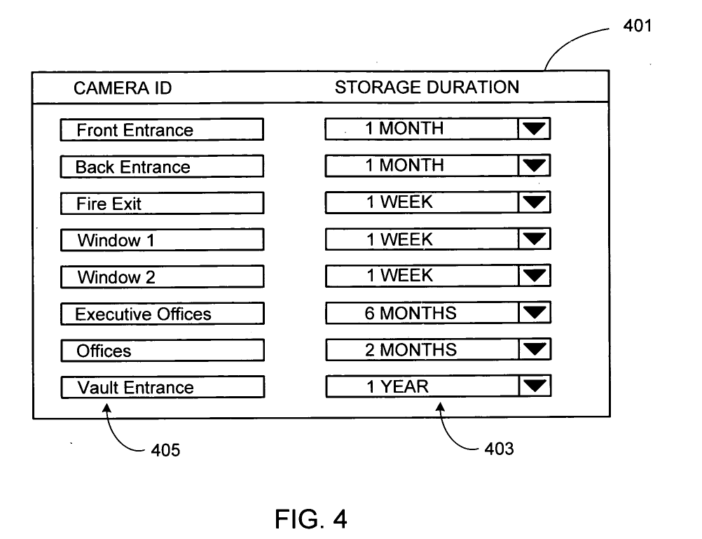

The data acquisition and storage attributes that are preferably user configurable include third party storage time (i.e., how long data is to be maintained within third party storage devices 313) and data transmission/acquisition frequency (i.e., how often data is acquired and transmitted to the storage site). As such parameters are typically camera specific, in the preferred embodiment each camera can be independently configured. Alternately, the settings for individual camera groups (e.g., vault cameras, door cameras, window cameras, etc.) are independently configurable. For example, video data from a high priority camera or group of cameras (e.g., bank vault entrance, cash register, etc.) can be frequently acquired and stored in the third party storage devices for a long period of time while video data from a low priority camera (e.g., hallway, etc.) can be acquired less frequently and maintained in storage for a shorter period of time. FIG. 4 illustrates an exemplary data screen 401 that allows the user to assign data storage periods 403 for each of the user's cameras 405. For simplicity, the user is allowed to select the storage period from a drop-down menu. It will be appreciated that although not shown in FIG. 4, preferably the user is also allowed to configure other rules relating to data acquisition and storage including, but not limited to, data acquisition frequency, data communication parameters (e.g., data rate, communication protocols, etc.), and video resolution. The last parameter, video resolution, is useful since in some instances a camera is only being used to monitor for activity (e.g., door openings) while in other instances a camera is recording details which would benefit from improved video resolution (e.g., bank transactions, gambling transactions, etc.).

As bandwidth may vary over time as is well known by those of skill in the art, at any given time the bandwidth of the link may be insufficient to transfer the desired amount of data. For example, a user may want all captured video data to be of high resolution and to be stored at the third party site. However, if the transmission bandwidth drops significantly it may only be possible, for example, to transmit a complete set of images with the desired resolution once every thirty minutes, thus leaving large blocks of time unrecorded. In order to overcome such a problem, in at least one embodiment of the invention the system varies one or more transmission variables (e.g., frame rate, compression ratio, image resolution, etc.) in response to bandwidth variations, thereby maximizing the usefulness of the transmitted data. The set of instructions that governs which variables are to be adjusted, the order of adjustment, the limitations placed on adjustment, etc. can either be user configured or third party configured, depending upon the overall system configuration.

As previously noted, in at least one preferred embodiment video data is locally buffered (e.g., within storage devices 325-327) before being transmitted via Internet 315 to third party site 301. Local data buffering allows the system to optimize data transmission, for example delaying data transmission rather than losing data when a link to Internet 315 is lost, or the bandwidth of the link is temporarily decreased. As previously noted, local data buffering also allows some data (e.g., low priority traffic data) to be maintained locally while other data (e.g., high priority data) is forwarded to the third party site. In order to minimize the risk of the data being compromised prior to being transmitted to the third party site, for example by a party breaking into the user site and damaging the user server/user storage device, preferably the data that is to be transmitted to the third party site is only buffered for a short period of time prior to transmission, for example on the order of 10 seconds or less.

Communication Protocols

In a conventional surveillance system, such as that shown in FIG. 2, the user is able to directly query the system, including on-site computer 207, in order to review data files, change system settings, etc. As a result of this configuration, any firewall associated with the surveillance system must allow at least limited queries received via the Internet, thereby providing a potential access point that can be used to hack, disable, or otherwise compromise the system. In contrast, in the preferred embodiment of the invention shown in FIG. 3, firewalls 329-331 do not accept inbound connections, thereby making the system secure from a conventional Internet launched attack.

Since in the preferred configuration individual user systems (e.g., systems 303-305) do not accept inbound connections, the present system provides an alternate means of communicating to an individual user system. Specifically, each user server includes an instruction to periodically send out a query to the third party system. The period can be configured to be on the order of seconds (e.g., every 10 seconds), on the order of minutes (e.g., every 10 minutes), on the order of hours (e.g., every 10 hours), on the order of days (e.g., once a day), etc. This query, also referred to herein as a heart beat, serves several purposes described in further detail below. Additionally, in at least one embodiment, a system user can force a user server to send out a heart beat by attempting to contact the user server in question. In this embodiment, if the user server receives such a communication, it will immediately respond by transmitting a heart beat to the third party site.

The periodic query, or heart beat, of each user system provides a convenient means for insuring that the user system is still functioning correctly. In its most rudimentary form, the user system heart beat verifies that the user system is still on-line and receiving power. Additionally, in a preferred embodiment, each user system is also configured to perform a self-check prior to sending out the heart beat, for example determining the status of each video camera (e.g., on, off, malfunctioning, etc.), the status of the data storage device (e.g., functioning properly, available memory, etc.), the operational status of other monitors (e.g., fire, smoke, CO, etc.) attached to the user's security system, etc. If third party system 301 does not receive a heart beat from a user when scheduled or within a pre-defined time period, or if the heart beat indicates that some aspect of the user's system is not operating properly, the third party system immediately notifies the user, the third party administrator, or both, so that corrective action can be taken. In a preferred embodiment, the notification process is fully automated. For example, the system can be configured to send an email to one or more designated addresses, the email providing the time and date when a scheduled heart beat was absent or when the heart beat noted malfunctioning equipment. Preferably third party system 301 also provides means for insuring that the detected problem is remedied, for example by sending messages until the heart beat returns to normal or sending messages to additional emergency email addresses provided by the user if corrective action has not been completed within a preset time period. Third party system 301 can also be configured to contact third party personnel. With the use of voice synthesizer, system 301 can also be configured to call user and/or third party personnel to report the detected system fault.

When a user system transmits a heart beat to third party system 301, it queries the third party system to determine if the third party system has any messages for it. As previously noted, this approach greatly improves network security by eliminating the need for the user system to accept inbound connections. Potential messages include user initiated requests for specific video data files (e.g., locally maintained video data) to be downloaded to the third party site; the availability of a software update (e.g., an operating system or application update); or new system configuration instructions. After receiving such a message the user server would proceed to transmit the desired data files, download the required update, or download the configuration instructions. In response to the message the user server can also be configured to schedule a future time to download the files/update/instructions.

In order to improve system security, in one embodiment each time a user system calls in to the third party system, i.e., transmits a heart beat, it also transmits a password that verifies that it is a legitimate user server. If the third party system is unable to verify the legitimacy of the user server, for example due to a faulty password, then the third party system preferably terminates contact with the user server. Third party system 301 also performs a series of security steps in accordance with predefined instructions, for example reporting the attempted contact from the non-recognized system to a system administrator or to an appropriate authority. The third party system may also be instructed to accept no further inbound communications from the non-recognized system. In order to reduce the chances of the password being copied, preferably after each time that the third party site verifies the legitimacy of the user server initiating contact via a heart beat, the third party system transmits a new password to the user server for use during the next heart beat. This process of continually verifying and changing passwords provides increased network security.

User Video Data Review

Preferably the user accesses the video data stored at site 301 via Internet 315 using any of a variety of devices. Depending upon the type of requested data and depending upon whether the user is initiating contact (e.g., data review) or is being contacted by the site 301 system (e.g., alarm notification), the user can use any of a variety of different communication means. In FIG. 3 a desktop computer 333 is shown connected to Internet 315, the connection being either wired or wireless. The party wishing to review video data or alter the user configurable aspects of the system accesses the system via a third party web site. At the third party site the party enters their identification data, typically a user ID and a password. Once this data has been entered and verified, the third party site determines to what accounts the party has access as well as the level of access. It will be appreciated that in a typical user configuration, different parties will be granted access to different accounts (e.g., different physical location, different cameras or camera groupings, etc.) as well as different levels of allowable system interaction (e.g., view data only, view/alter user configuration, etc.).

As described in detail below, the system can be configured to allow an end user to access and review captured video data in a variety of ways, for example based on a period of time or on the level/time that activity is detected by a camera. Additionally, and as previously noted, a user is also able to review data that is stored at the local user site rather than at the third party site; an example of such data being low priority, traffic data. When the user requests to review such data, the data in question is flagged by the third party site. Then when the local user system checks in via the previously described heart beat protocol, it receives a message to transmit the data in question to the third party site. Although a variety of techniques can be used to notify the party wishing to review the data when the data has been downloaded and readied for review, in at least one preferred embodiment a flag or other indicator associated with the camera, date and time in question changes color depending upon whether the data has been downloaded to the third party site (e.g., offsite data) or is resident at the local user's site (e.g., onsite data). As a result of this approach, an authorized party is able to retrieve locally stored data without compromising the system's network security or requiring that the user firewall (e.g., firewalls 329-331) ever accept an inbound connection.

### Alternate System Configurations

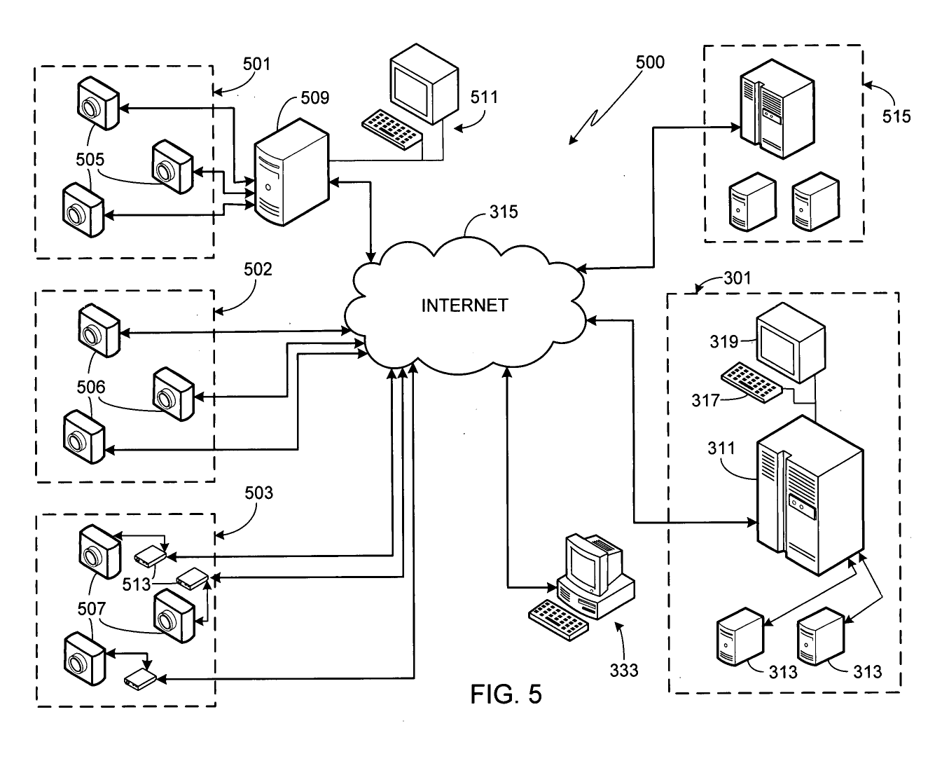

FIG. 5 illustrates other configurations that the invention can employ. As with the other embodiments, system 500 utilizes a third party site 301 that is remotely located from the users. System 500 also shows three exemplary users 501-503, each of which includes multiple cameras 505-507, respectively. Note that this embodiment, as with the previous embodiment, is not limited to a single type of camera. For illustration purposes, FIG. 5 shows three exemplary methods of coupling the individual cameras and the user systems to third party site 301 via Internet 315.

Cameras 505 of user 501 are each coupled to a local area network (LAN) 509 which is, in turn, connected to Internet 315. If desired, a local monitoring station 511 can be connected to LAN 509, thus allowing real-time review of video data prior to, or simultaneously with, storage and data processing at site 301. Alternately, a user (e.g., user 502) can utilize cameras 506, each of which is capable of direct connection, wired or wireless, to Internet 315. Alternately, a user (e.g., user 503) can utilize cameras 507 in conjunction with modems 513 to connect to Internet 315.

As in system 300, preferably the user accesses the video data stored at site 301 via Internet 315 using a desktop computer 333, or similar means, wired or wirelessly connected to the Internet. Although not shown in FIG. 5, preferably a firewall is interposed between Internet 315 and each connected system.

In this and other embodiments, it will be appreciated that one or more additional third party sites 515 can be coupled to the first third party site 301 via Internet 315, thereby providing redundancy and/or increased data storage capacity. Preferably additional third party sites 515 are geographically located at some distance from the first third party site 301 at a location that is unlikely to be affected by any system disturbance (e.g., power outage, natural disaster, etc.) affecting site 301.

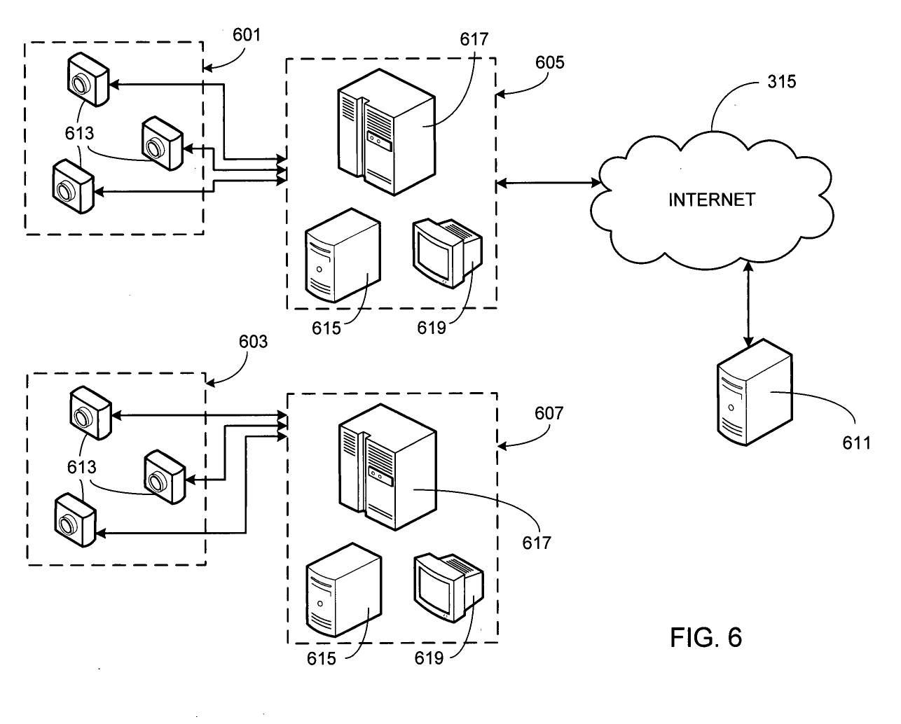

Although the preferred embodiment of the invention utilizes an off-site location under third party control to store, analyze and manipulate video data from multiple users, it should be appreciated that many of the benefits of the present invention can also be incorporated into a video handling system that is located and operated by a single user. For example, FIG. 6 illustrates two separate users 601 and 603 utilizing independent, self-contained data storage and handling systems 605 and 607, respectively. System 605 is coupled to Internet 315, thus allowing it to acquire the desired video handling software, software updates and integration aid from third party server 611, also coupled to Internet 315. In contrast system 607 is not coupled to Internet 315, thus requiring data handling software to be acquired and installed using a non-Internet based means (e.g., disk). It will be appreciated that both systems 605 and 607 include cameras 613, application/processing servers 615, data storage means 617, and user monitoring stations 619.

### Data Review Aids

The present invention provides a variety of techniques that can be used to quickly and efficiently review and/or characterize acquired video data regardless of where the video data is stored (e.g., at third party site 301 or a user location). It will be appreciated that some, all, or none of the below-described aids may be used by a particular user, depending upon which system attributes are offered as well as the user's requirements (e.g., level of desired security, number of cameras within the user's system, etc.).

The description of the data review aids provided below assumes that the user has input their basic camera configuration (e.g., number of cameras, camera identifications, camera locations) and system configuration (e.g., communication preferences and protocols) into the system.

Timeline Activity

The timeline activity aid provides a user with an on-line graphical view of one or more of the user's cameras for a user selected date and period of time. Thus, for example, user 303 can query third party system 301 via computer 333 or other means, requesting to view the activity for a selected period of time and for one or more of the user's cameras. In response to such a query, third party system 301 would provide user 303 with the requested data in an easily reviewable graphical presentation. If the user finds an anomaly in the data, or simply decides to review the actual video data from one of the cameras in question, the user can do so by inputting another query into system 301. In a preferred embodiment of the invention, the user can input their second query by placing the cursor on the desired point in a particular camera's timeline using either “arrow” keys or a mouse, and then selecting the identified portion by pressing “enter” or by clicking a mouse button. Third party system 301 then transmits the designated video sequence to the user via Internet 315.

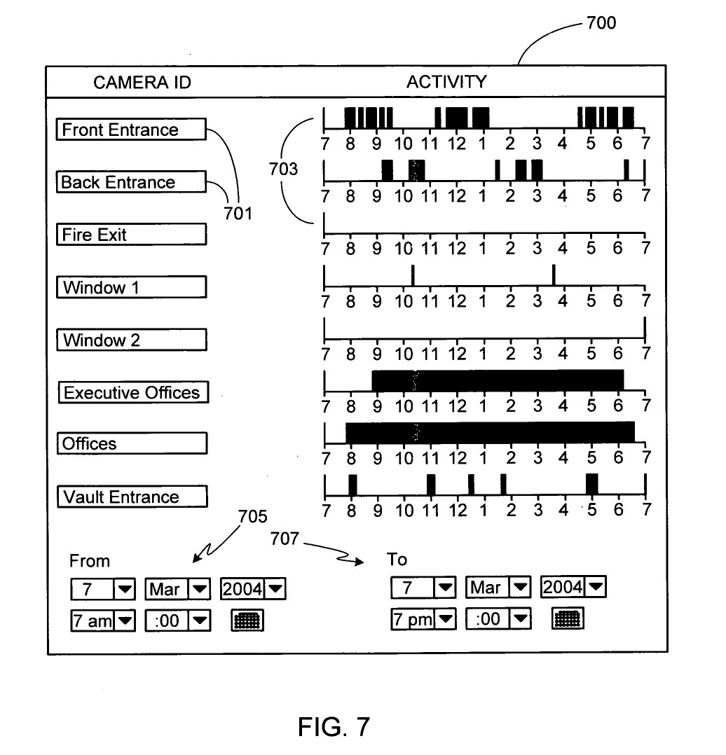

FIG. 7 illustrates one possible screen 700 that the graphical activity timeline can use. As shown, the identity 701 of each selected camera is provided as well as the activity timeline 703 for each camera. The user selects both the starting date and time (e.g., pull-down menus 705) and the ending date and time (e.g., pull-down menus 707). For purposes of this embodiment, activity is represented by a spike on an activity timeline 703, activity being defined as a non-static image, e.g., an image undergoing a relatively rapid change in parameters. For example, a spike in an activity timeline 703 can indicate that the camera in question recorded some movement during the identified time. As techniques for comparing captured frames of video data to one another are well known by those of skill in the art, as are techniques for setting differentiation thresholds for the two frames, detailed description of such techniques are not provided herein.

The primary benefit of the activity timeline is that it allows a user to quickly review acquired video data without actually viewing the video data itself. This is especially important for those users, for example large companies, that may employ hundreds of surveillance cameras. Security personnel, either viewing camera data real-time or from records, may be so overwhelmed with data that they miss a critical security breach. In contrast, the present invention allows a single person to quickly review hours, days or weeks of data from hundreds of cameras by simply looking for unexpected activity. For example, it would only take security personnel reviewing the data presented in FIG. 7 seconds to note that at 7 pm the back entrance, second window and vault cameras all showed activity. Assuming that such activity was unexpected, the security personnel could then review the video data acquired by each of the cameras to determine if, in fact, a security breach had occurred.

In an alternate embodiment of this aspect of the invention, the user can request to view the activity timeline only for those cameras recording activity during a user selected period of time. Thus, for example, if the user with the data illustrated in FIG. 7 requested to view the timeline for any camera which recorded activity at 7 pm on Mar. 7, 2004, only activity timelines for the back entrance, second window and vault entrance cameras would be presented. This capability is especially helpful when the user has hundreds of cameras.

Video View Set-Up

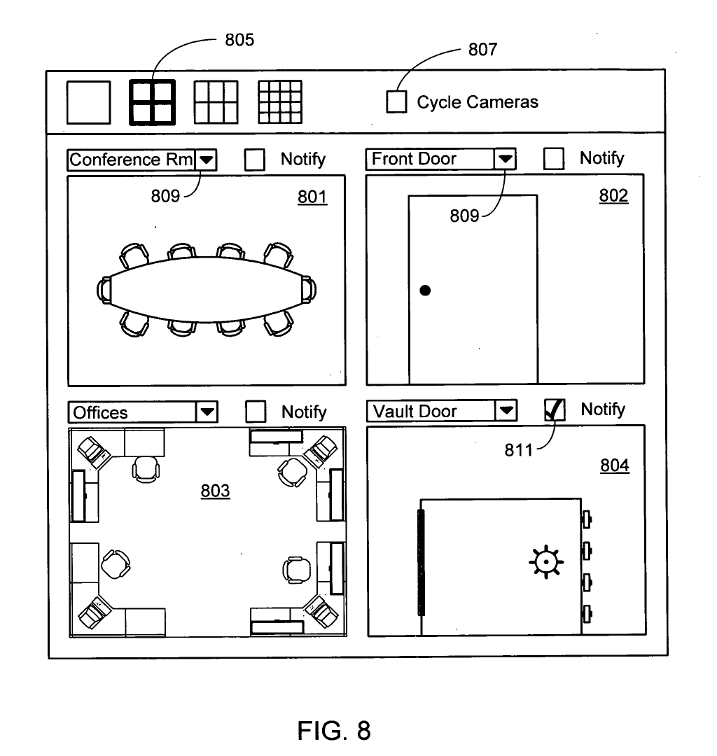

In another aspect of the invention, the user can individualize the form that video data is to be presented. For example as shown in FIG. 8, the user selects the number of video images 801-804 to be presented on a single screen by highlighting, or otherwise identifying, the desired number of camera images to be simultaneously viewed (e.g., four screen ‘button’ 805 is highlighted in FIG. 8). The user can also select whether or not to cycle the camera images through the presented windows (e.g., ‘button’ 807). In this embodiment the user can also select, via pull-down menus 809, which camera images are to be presented in each of the screen's selected window panes.

In addition to allowing a user to individualize camera image presentation, in the preferred embodiment of the invention the user can select (via ‘button’ 811 or similar means) whether or not they wish to be notified when motion is detected on a particular camera. This aspect of the invention can be used either while viewing camera data real-time or viewing previously recorded video data. Thus, for example, a user can request notification for those cameras in which activity is not expected, or not expected for a particular time of day. Notification can be by any of a variety of means including, but not limited to, audio notification (e.g., bell, pre-recorded or synthesized voice announcements which preferably include camera identification, etc.), video notification (e.g., highlighting the camera image in question, for example by changing the color of a frame surrounding the image, etc.), or some combination thereof.

Geochronshape Rules

In another aspect of the invention, the user is able to set-up a sophisticated set of rules that are applied to the acquired camera images and used for flagging images of interest. The flags can be maintained as part of the recorded and stored video data, thus allowing the user at a later time to review data that was identified, based on the geochronshape rules, to be of potential interest. Alternately, or in addition to flagging the stored data, the flags can also be used as part of a notification system, either as it relates to real-time video data or video data that has been previously recorded.

In the preferred embodiment, the user is able to divide an image into multiple zones (the “geo” portion of the geochronshape rules) and then set the rules which apply to each of the identified zones. The rules which can be set for each zone include time based rules (the “chron” portion of the geochronshape rules) and shape based rules (the “shape” portion of the geochronshape rules).

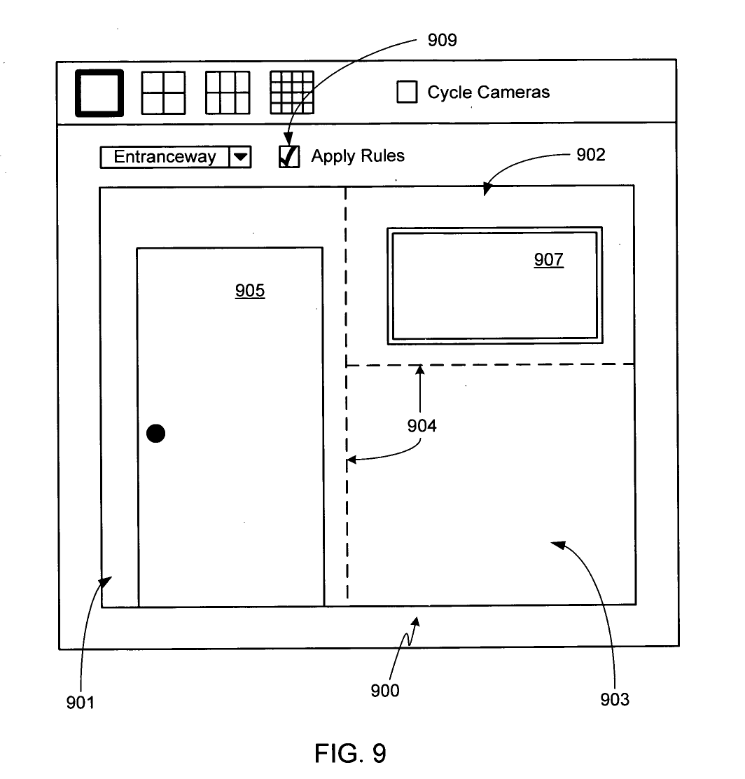

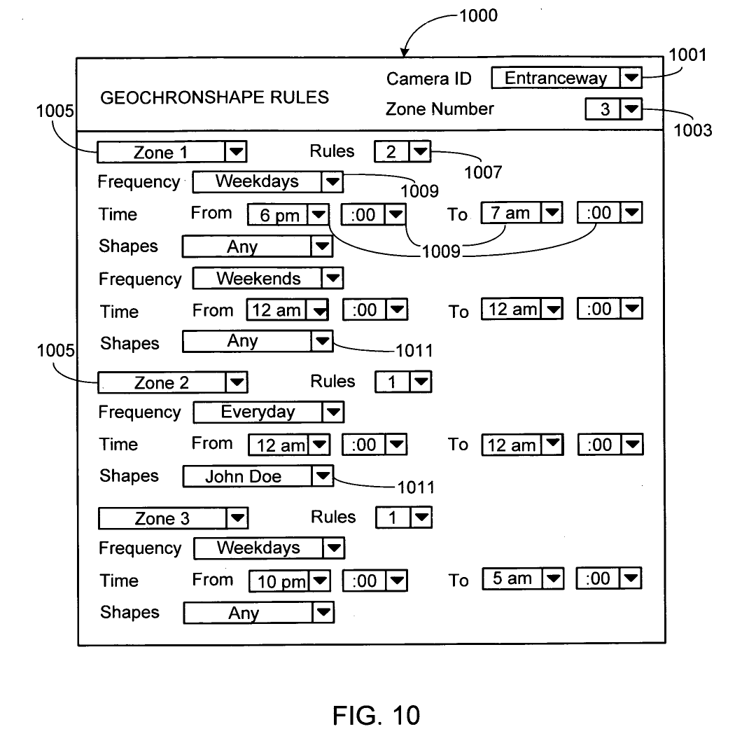

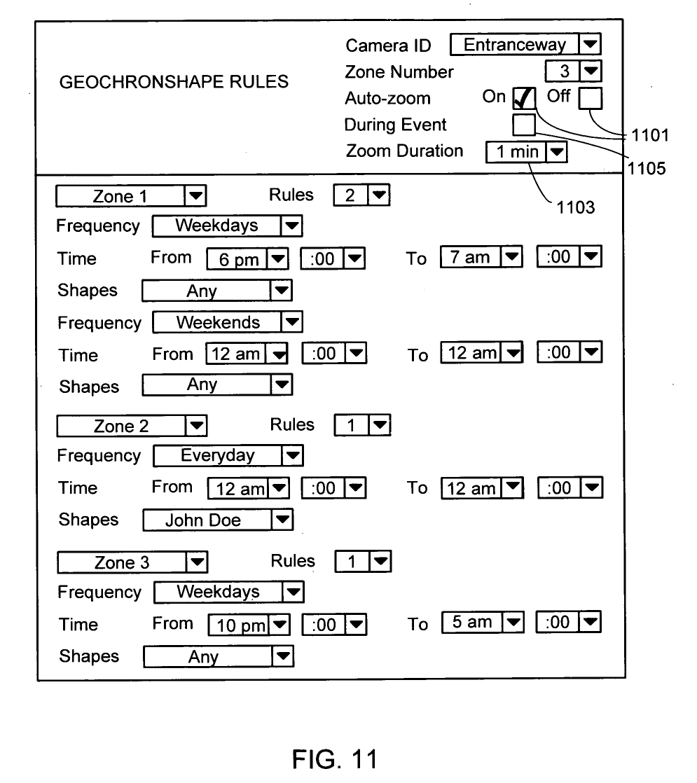

As previously noted, using this aid the user identifies specific areas or zones within a particular camera's field of view to which specific rules are applied. For example, FIG. 9 is an illustration of a camera's field of view 900 that the user has divided into three zones 901-903 as indicated by dashed lines 904. Zone 901 includes entrance door 905, zone 902 includes outside window 907, and zone 903 includes a portion of a hallway. Preferably the user selects, per camera, whether or not to apply the geochronshape rules, for example by selecting button 909 as shown. It is understood that although the screen in FIG. 9 shows a single camera's field of view 900, the screen could be divided into multiple camera images, for example as described above with respect to FIG. 8. A separate data input screen 1000 shown in FIG. 10 provides the user with a means of entering the rules for each zone. It will be appreciated that screen 1000 is only meant to be illustrative of one type of data input screen and is not intended to limit either the types of rules or the manner in which they can be input into the system.

When the user inputs zone rules into screen 1000, the user must first select the camera ID to which the rules apply (e.g., pull-down menu 1001) and the total number of zones that are to be applied to that camera (e.g., pull-down menu 1003). For each zone, identified by a pull-down menu 1005, the user selects the number of rules to be applied (e.g., pull-down menu 1007). The user can then select when the rules apply using pull-down menus 1009. For example in the data shown in FIG. 10, zone 1 has two rules, one applicable on weekdays from 6 pm to 7 am and the second applicable 24 hours a day on weekends. As illustrated, zone 2 is active 24 hours a day, every day, while zone 3 is only active on weekdays from 10 pm to 5 am. With respect to shapes, pull-down menu 1011 is used to select the shape of the object to be detected. Preferably the user can select both from system shapes and from user input shapes. For example, typically the system includes an “any” shape, thus allowing notification to occur if any object, regardless of shape or size, is detected within the selected period of time. Thus in this example the zone 1 rules are set to determine if there is any movement, such as the opening of door 905, from 6 pm to 7 am (i.e., rule 1 for zone 1) or at anytime during the weekend (i.e., rule 2 for zone 1). The system shapes may also include size shapes, thus allowing the user to easily allow small objects (e.g., mice, cats, etc.) to enter the zone without causing a detection alarm by the system. User input shapes may include people or objects that are of particular concern (e.g., a particular person, a gun shape in a banking facility, etc.). In this example the zone 2 rules are set to detect if a particular person (i.e., John Doe) passes window 907 at any time.

It will be appreciated that although the preferred embodiment of the invention includes zone, time and shape rules as described above (i.e., geochronshape rules), a particular embodiment may only include a subset of these rules. For example, the system can be set-up to allow the user to simply select zones from a preset number and location of zones (e.g., split screen, screen quadrants, etc.). Alternately, the system can be set-up to only allow the user to select zone and time, without the ability to select shape. Thus in such a system any motion within a selected zone for the selected time would trigger the system. It is understood that these are only a few examples of the possible system permutations using zone, time and shape rules, and that the inventors clearly envision such variations.

Auto-Zoom

In another aspect of the invention, the user is able to select an auto-zoom feature that operates in conjunction with the geochronshape rules described above. Typically the user selects this feature on the geochronshape rules screen, as illustrated in FIG. 11, although it should be understood that the user may also select such a feature on another data input screen, for example a data input screen which allows the user to select the features to be applied to all of their captured video data. The screen example shown in FIG. 11 is identical to that shown in FIG. 10, with the addition of auto-zoom selection buttons 1101, 1103 and 1105.

When the auto-zoom function is selected, as in FIG. 11, the camera zooms in on a particular zone whenever a geochronshape rule associated with that zone is triggered. Camera zoom can operate in a variety of ways, depending upon how the system is set-up. Preferably when the auto-zoom feature is triggered, the camera automatically repositions itself such that the zone of interest is centered within the camera's field of view, then the camera zooms in until the zone in question completely fills the camera's field of view. Alternately, the camera can automatically reposition itself to center the zone of interest, and then zoom in by a preset amount (e.g., 50%).

Camera repositioning, required to center the zone of interest in the camera's field of view, can be performed either mechanically or electronically, depending upon a particular user's system capabilities. For example, one user may use cameras that are on motorized mounts that allow the camera to be mechanically repositioned as desired. Once repositioned, this type of camera will typically use an optical zoom to zoom in on the desired image. Alternately, a user may use more sophisticated cameras that can be repositioned electronically, for example by selecting a subset of the camera's detector array pixels, and then using an electronic zoom to enlarge the image of interest.

Preferably after zooming in on the zone which had a triggering event (e.g., motion), the camera will automatically return to its normal field of view rather than staying in a ‘zoom’ mode. The system can either be designed to remain zoomed in on the triggering event until it ceases (e.g., cessation of motion, triggering shape moving out of the field of view, etc.) or for a preset amount of time. The latter approach is typically favored as it both insures that a close-up of the triggering event is captured and that events occurring in other zones of the image are not overlooked. In the screen illustrated in FIG. 11, once the user selects the auto-zoom feature, they also set either a duration time from a pull-down menu (e.g., button 1103), or event monitoring (e.g., button 1105).

Auto-Focus

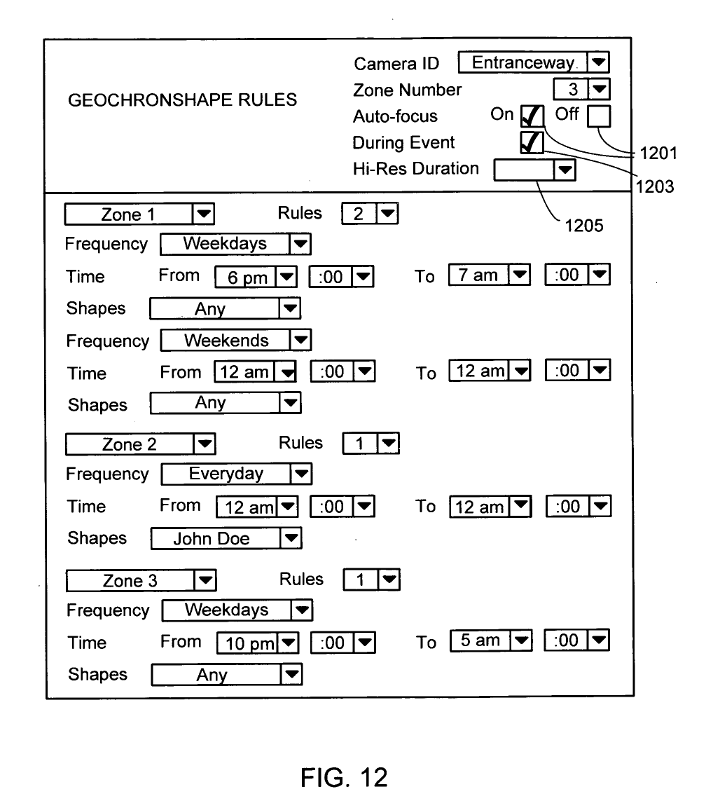

In another aspect of the invention, the user is able to select an auto-focus feature that operates in conjunction with the geochronshape rules described above. As opposed to a photography/videography auto-focus system in which the lens is automatically adjusted to bring a portion of an image into focus, preferably the auto-focus feature of the current invention alters the resolution of a captured image. Typically the user selects this feature on the geochronshape rules screen, as illustrated in FIG. 12, although it should be understood that the user may also select such a feature on another data input screen, for example a data input screen which allows the user to select the features to be applied to all of their captured video data. The screen example shown in FIG. 12 is identical to that shown in FIG. 10, with the addition of auto-focus selection buttons 1201, 1203 and 1205.

When the auto-focus function is selected, as in FIG. 12, the camera increases the resolution whenever an event triggers one of the geochronshape rules. The system can either be set-up to increase the resolution of the entire field of view or only the resolution in the zone in which the triggering event occurred. Preferably the system is set-up to allow the user to either maintain high resolution as long as the triggering even is occurring, through the selection of the event button 1203 as illustrated, or for a set period of time (e.g., by selecting a time using pull-down menu 1205).

One of the benefits of the auto-focus feature is that it allows image data to be transmitted and/or stored using less expensive, low bandwidth transmission and storage means most of the time, only increasing the transmission and/or the storage bandwidth when a triggering event occurs.

Auto-Flag

The auto-flag feature is preferably used whenever the monitored image includes multiple fields of view such as previously illustrated in FIG. 8. The auto-flag feature insures that the user does not miss an important event happening in one image while focusing on a different image. For example, a security guard monitoring a bank of camera images may be focused on a small fire occurring outside the building within the view of an external camera, and not notice a burglary occurring at a different location.

Preferably the auto-flag feature is used in conjunction with the geochronshape rules, thus allowing the user to set-up a relatively sophisticated set of rules which trigger the auto-flag feature. The auto-flag feature can also be used with a default set of rules (e.g., motion detection within a field of view).

The auto-flag feature can be implemented in several ways with an audio signal, a video signal, or a combination of the two. For example, an audio signal (e.g., bell, chime, synthesized voice, etc.) can sound whenever one of the geochronshape rules is triggered. If a synthesized voice is used, preferably it announces the camera identification for the camera experiencing the trigger event. A geochronshape trigger can also activate a video trigger. Preferably the video indicator alters the frame surrounding the camera image in question, for example by highlighting the frame, altering the color of the frame, blinking the frame, or some combination thereof. In the preferred embodiment both an audio signal and a video signal are used as flags, thus insuring that the person monitoring the video screens is aware of the trigger and is quickly directed to the camera image in question.

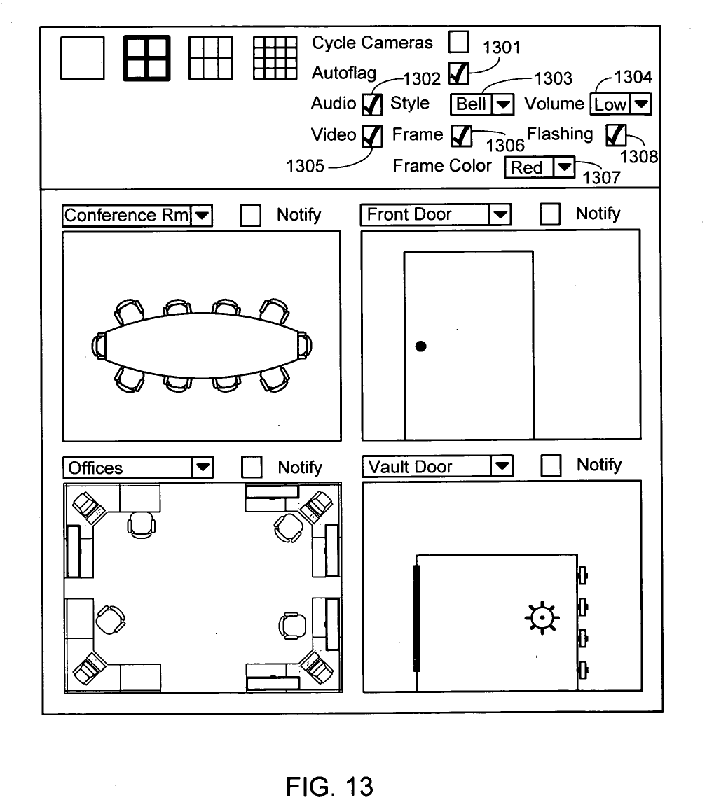

FIG. 13 is similar to FIG. 8 except for the addition of auto-flag buttons 1301-1308. As with the other data review features, there are numerous ways to implement the auto-flag feature. For example, the auto-flag buttons could also be located on the geochronshape rules screen, a dedicated auto-flag screen, a basic set-up screen or other screen. As shown in FIG. 13, the user selects the auto-flag feature by highlighting button 1301. If the user selects to have an audio flag as indicated by the selection of button 1302, preferably the user can also set the indicator type (e.g., pull-down menu 1303) and volume (e.g., pull-down menu 1304). If the user selects to have a video flag as indicated by the selection of button 1305, preferably the user can also set-up specifics relating to the video flag (e.g., frame: button 1306; frame color: button 1307; flashing frame: button 1308; etc.).

Action Overview

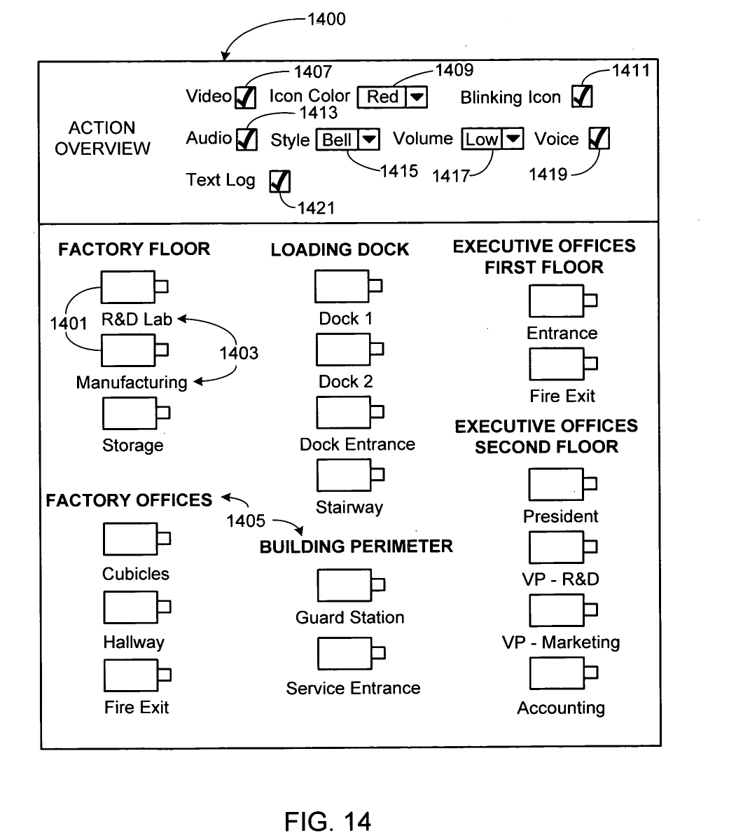

The action overview feature allows the user to simultaneously monitor hundreds of cameras. As illustrated in FIG. 14, an icon 1401 is used to indicate each camera. Associated with each camera icon is a camera identifier 1403, thus allowing rapid identification of a particular camera's location. Preferably the user is able to arrange the camera icons 1401 according to a user preference, thus achieving a logical arrangement. For example, in the illustration the icons are arranged by building and/or building area identifiers 1405 (e.g., factory offices, factory floor, loading docks, offices—1^{st} floor, offices—2^{nd} floor, fence perimeter, etc.).

Preferably the action overview feature is used in conjunction with the geochronshape rules, thus allowing the user to set-up a relatively sophisticated set of rules which trigger this feature. The action overview feature can also be used with a default set of rules (e.g., motion detection within a camera's field of view).

Regardless of whether the action overview feature is used in conjunction with the geochronshape rules, or a default set of rules, once a triggering event occurs the camera icon associated with the camera experiencing the triggering event changes, thus providing the user with a means of rapidly identifying the camera of interest. The user can then select the identified camera, for example by highlighting the camera and pressing “enter” or placing the cursor on the identified camera and double clicking with the mouse. Once selected, the image being acquired by the triggered camera is immediately presented to the user, thus allowing quick assessment of the problem.

The action overview feature can be implemented in several ways with a video signal, an audio signal, or a combination of the two. For example, the user can select video notification (e.g., button 1407), the color of the icon once triggered (e.g., pull-down menu 1409) and whether or not to have the icon blink upon the occurrence of a triggering event (e.g., button 1411). The user can also select audio notification (e.g., button 1413), the type of audio sound (e.g., pull-down menu 1415), and the volume of the audio signal (e.g., pull-down menu 1417). Preferably the user can also select to have a synthesized voice announce the location of the camera experiencing the triggering event. In the preferred embodiment both an audio signal and a video signal are used, thus insuring that the person monitoring the camera status screen is aware of the triggering event and is quickly directed to the camera image in question.

Action Log

The action log feature generates a textual message upon the occurrence of a triggering event, the triggering event either based on the previously described geochronshape rules or on a default set of rules (e.g., motion detection). This feature is preferably selected on one of the user set-up screens. For example, screen 1400 of FIG. 14 includes a text log button 1421 (shown as selected in FIG. 14) which is used to activate this feature.

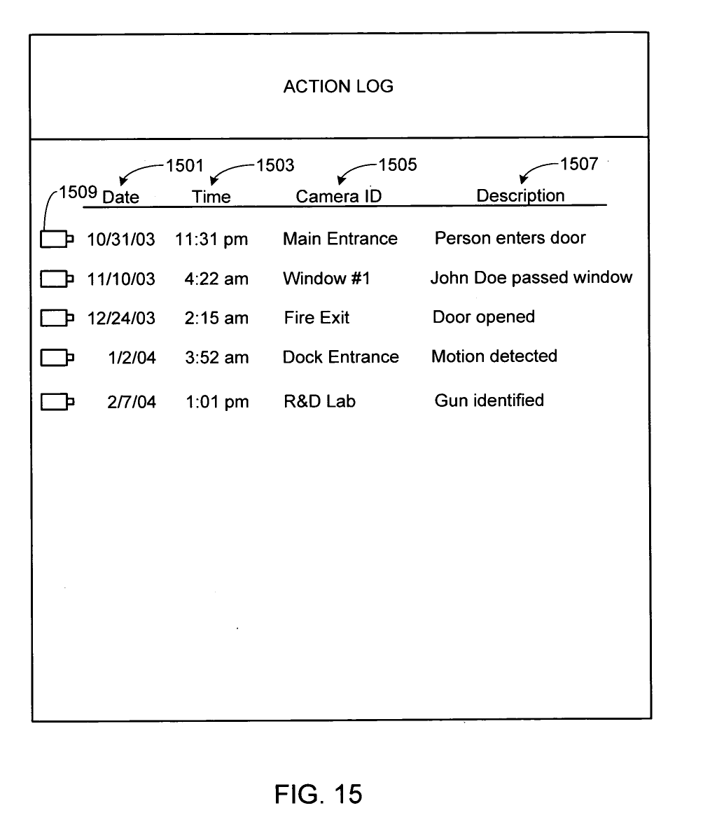

Once activated, the action log feature creates a text message for each triggering event, the messages being combined into a log that the user can quickly review. FIG. 15 illustrates a possible log in accordance with the invention. As shown, the log includes the event date 1501, the event time 1503 and the identification 1505 of the camera monitoring the triggering event. Depending upon the sophistication of the image recognition software used within the system, the log may also include a brief description 1507 of the event (e.g., door opened, entry of person after hours, etc.). In at least one embodiment, the description is added, or edited, by the system user after reviewing the event. In the preferred embodiment, the user can immediately view the image created in response to the triggering event, either by selecting the log entry of interest or selecting an icon 1509 adjacent to the log entry.

### Notification System

In another aspect of the invention, a notification system is integrated into the third party site. There are a variety of ways in which the notification system can be implemented, depending upon both the capabilities of the third party site and the needs of the user. Depending upon implementation, the notification system allows the user, or someone designated by the user, to be notified upon the occurrence of a potential security breach (e.g., violation of a geochronshape rule) or other triggering event (e.g., loss of system and/or subsystem functionality such as a camera going off-line and no longer transmitting data). As described in further detail below, notification can occur using any of a variety of means (e.g., email, telephone, fax, etc.).

A number of benefits can be realized using the notification system of the invention. First, it allows a user to minimize personnel tasked with actively monitoring video imagery captured by the user's cameras since the notification system provides for immediate notification when a triggering event occurs. As a result, in at least one application security personnel can be tasked with other jobs (e.g., actively patrolling the area, etc.) while still being able to remotely monitor the camera system. Second, the system typically results in quicker responses to security breaches as the system can be set-up to automatically notify personnel who are located throughout the premises, thus eliminating the need for personnel monitoring the video cameras to first notice the security breach, decide to act on the breach, and then notify the roving personnel. Third, the system can be set-up to automatically send the user text descriptions of the triggering event (e.g., door opened on NE entrance, gun identified near vault, etc.) and/or video data (e.g., stills, video clip from the camera), thus allowing the user (e.g., security personnel) to handle the situation more intelligently (e.g., recognize the possible intruder, recognize the likelihood of the intruder being armed, etc.). Fourth, the system minimizes mistakes, such as mistakenly notifying the police department in response to a triggering event, by allowing for the immediate notification of high level personnel (e.g., head of security, operations manager, etc.) and/or multiple parties, thus insuring rapid and thorough review of the triggering event. Fifth, the system insures that key personnel are immediately notified of triggering events.

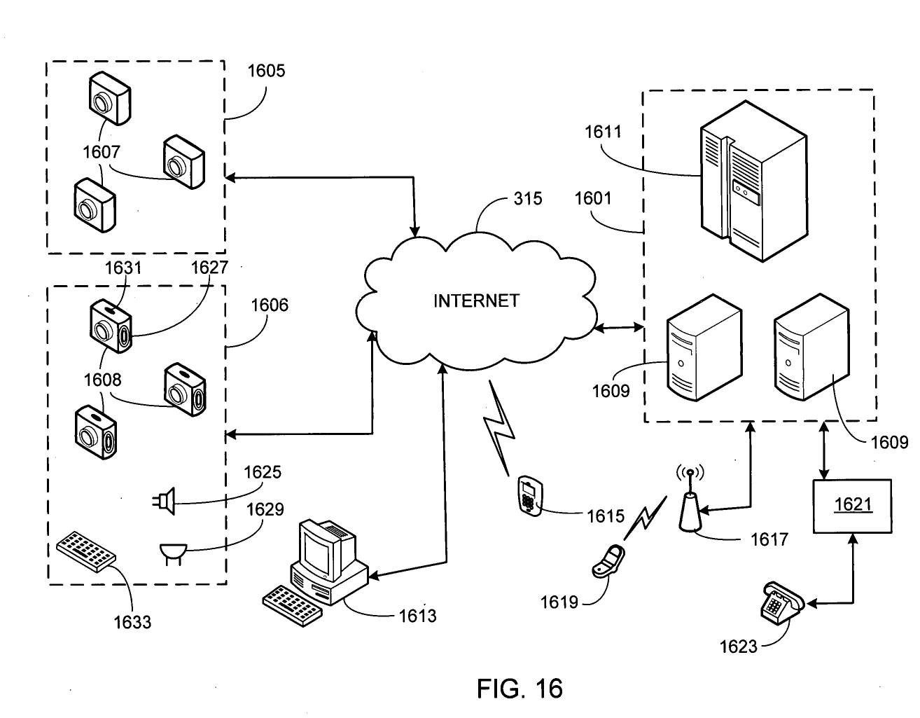

FIG. 16 is an illustration of an embodiment of the invention, the figure showing a variety of methods for notifying a system user of the status of the system. It will be appreciated that user notification can be set-up to notify the user in response to any of a variety of conditions, including providing periodic status reports, in response to an event triggering a default rule (e.g., motion detection in a closed area), or in response to an event triggering a geochronshape rule.

As shown in FIG. 16, a third party site 1601 is coupled to Internet 315. As previously described, the third party site is remotely located from the users and is used to store, analyze and handle the video data acquired by multiple, unrelated users (represented by users 1605 and 1606, utilizing cameras 1607 and 1608, respectively) and communicated to third party site 1601 via Internet 315. As previously noted, there are a variety of techniques, well known by those of skill in the art, for transmitting/receiving video data over the Internet and therefore further detailed description is not provided herein.

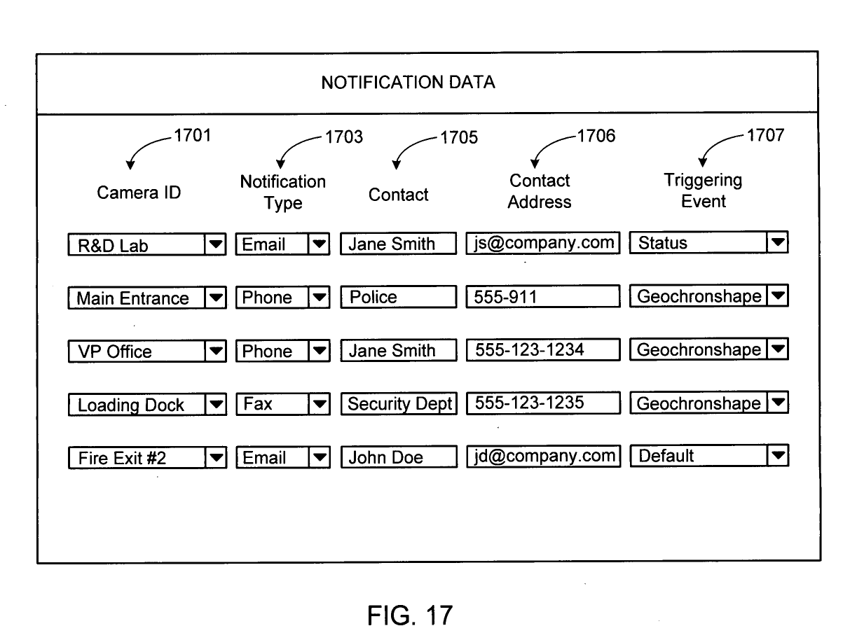

One or more servers 1609 and one or more storage devices 1611 are located at third party site 1601. In addition to communication and/or processing and/or analyzing video data as previously noted, servers 1609 are also used for system configuration and to transmit notification messages to the end users, locations/personnel designated by the end users, or both. The users, preferably using an input screen such as that illustrated in FIG. 17, designate for each camera identification 1701 (or for groups of identified cameras) the manner in which notification messages are to be sent (e.g., pull-down menu 1703), contact/address information 1705-1706, and the triggering event for receiving notification (e.g., pull-down menu 1707). A benefit of using a data input screen such as that shown in FIG. 17 is that it allows users, assuming they have been granted access, to remotely reconfigure the system as needed. Thus, for example, a user can remotely change from receiving notification messages via email to receiving an audio notification message on their cell phone.

As previously noted, third party site 1601 is coupled to Internet 315, thus allowing access by an Internet coupled computers (e.g., desktop computer 1613), personal digital assistants (e.g., PDA 1615), or other wired/wireless devices capable of communication via Internet 315. Preferably third party site 1601 is also coupled to one or more telephone communication lines. For example, third party site 1601 can be coupled to a wireless communication system 1617, thus allowing communication to any of a variety of wireless devices (e.g., cell phone 1619). Third party site 1601 can also be coupled to a wired network 1621, thus allowing access to any of a variety of wired devices (e.g., telephone 1623).

Notification can either occur when the user/designee requests status information (i.e., reactive system), or in response to a system rule (i.e., proactive system). In the proactive approach the system can be responding to a user rule or a system default rule. Regardless of whether the notification message is a reactive message or a proactive message, preferably the message follows a set of user defined notification rules such as those illustrated in FIG. 17. If desired, the notification rules can be set-up to allow for a single triggering event to cause multiple messages to be sent to multiple parties and/or using multiple transmission means.

Textual Notification

In a preferred embodiment, the third party site of the invention notifies users or other user designees with a text message. Depending upon the system configuration and the requirements of the user, such text messaging can range from a simple alert message (e.g., “system breach”) to a message that provides the user/designee with detailed information regarding the triggering event (e.g., date, time, camera identification, camera location, triggered geochronshape rule, etc.). The text message can be sent via email, fax, etc. In one aspect of the invention, rather than actively sending the text message, the message is simply posted at an address associated with, or accessible by, the particular user/user designee, thus requiring that the user/designee actively look for such messages. This approach is typically used when the user/designee employs one or more personnel to continually review video imagery as the data is acquired.

Audio Notification

In a preferred embodiment, the third party site of the invention notifies users or other user designees with an audio message. Depending upon the system configuration and the requirements of the user, such audio messaging can range from a simple alert message (e.g., “the perimeter has been breached”) to a message that provides the user/designee with detailed information regarding the triggering event (e.g., “on Oct. 12, 2003 at 1:32 am motion was detected in the stairway outside of the loading dock”). The audio message can either be sent by phone automatically when the event in question triggers the geochronshape rule, default rule, etc., or the audio message can be sent in response to a user/designee status request. Although the system can use pre-recorded messages, preferably the system uses a voice synthesizer to generate each message in response to the triggering event.

Video Notification

In a preferred embodiment, the third party site of the invention notifies users or other user designees with a video message, preferably accompanying either an audio message or a text message. Typically the video aspect of the message includes a portion of the video imagery captured by the triggered camera, for example video images of the intruder who triggered an alarm. The video imagery may also include additional information presented in a visual format (e.g., location of the triggered camera on a map of the user's property). The video message can either be sent automatically when the event in question triggers the geochronshape rule, default rule, etc., or the video message can be sent in response to a user/designee status request, or the video message can simply be accessible to the user/designee at a web site (e.g., third party hosted web site to which each user/designee has access). The video data sent in the video notification can either be live camera data, camera data that has been processed, or some combination thereof.

As previously described in the specification, the preferred embodiment of the present invention includes video processing capabilities. For example, the system can be set-up to review acquired video images looking for specific shapes (e.g., a person, a gun-shaped object, etc.). This data review process can also be configured to be dependent upon the day of the week, the time of the day, or the location of the object within a video image. Accordingly such capabilities allow the notification system to react more intelligently than a simple breach/no breach alarm system. Thus the system is able to notify the user/designee of the type of security violation, the exact location of the violation, the exact time and date of the violation as well as provide imagery of the violation in progress. This processing system, as previously disclosed, can also enhance the image, for example by zooming in on the target, increasing the resolution of the image, etc. Such intelligent analysis capabilities decreases the likelihood of nuisance alarms.

Fully Automated Surveillance and Notification System

As described above, the present invention provides the user with the ability to set-up a variety of rules that not only control the acquisition of camera data, but also what events and/or objects violate the user defined rules. Additionally, the system can be set-up to automatically notify the user by any of a variety of means whenever the rules are violated. Therefore in a preferred embodiment of the invention, the data acquired by the user's cameras are automatically reviewed (i.e., no human review of the acquired data) and then, when the system determines that a violation of the user defined rules has occurred, the system automatically notifies (i.e., no human involvement) the user/designee according to the user-defined notification rules. The automated aspects of the invention can either reside locally, i.e., at the user's site, or remotely, i.e., at a third party site.

The benefits of a fully automated system, in other words a system that does not require human involvement during day to day operations, are numerous. First, after the initial set-up expense, the typical operational cost is much less than that of a system requiring personnel to monitor a bank of cameras and report possible security violations. Second, the automated system is a more reliable system as it is not prone to human error (e.g., falling asleep on the job or watching one camera monitor while a violation is occurring in the field of view of another camera). Third, there is no notification delay in an automated system as there often is in a non-automated system in which there may be both data review and data reporting errors/delays. Fourth, a fully automated system, or at least a system using a fully automated notification process, can easily and reliably send notification messages to different people, depending upon which camera is monitoring the questionable activity. Thus the person with the most knowledge about a particular area (e.g., loading dock foreman, office manager, VP of operations, etc.) receives the initial notification message or alarm and can decide whether or not to escalate the matter, potentially taking the matter to the authorities. This, in turn, reduces the reporting of false alarms.

### Automated Interrogation System

In another embodiment, the automated surveillance system of the invention includes the ability to automatically interrogate a potential intruder. Although the software application for this embodiment is preferably located at the remotely located third party site, e.g., site 301 of FIG. 3 or site 1601 of FIG. 16, it will be appreciated that it could also operate on an on-premises system such as either system 605 or 607 shown in FIG. 6.

In operation once a potential intruder is detected, preferably using image recognition software and a set of rules such as the geochronshape rules described above, the system notifies the potential intruder that they are under observation and requests that they submit to questioning in order to determine if they are a trespasser or not. If the identified party refuses or simply leaves the premises, the automated system would immediately contact the party or parties listed in the notification instructions (e.g., authorities, property owner, etc.). If the identified party agrees to questioning, the system would ask the party a series of questions until the party's identity is determined and then take appropriate action based on the party's identity and previously input instructions (e.g., notify one or more people, disregard the intruder, etc.).

Preferably the questions are a combination of previously stored questions and questions generated by the system. For example, the system may first ask the intruder their identity. If the response is the name of a family member or an employee, the system could then ask appropriate questions, for example verifying the person's identity and/or determining why the person is on the premises at that time or at that particular location. For example, the intruder may be authorized to be in a different portion of the site, but not in the current location. Alternately, it may be after hours and thus at a time when the system expects the premises to be vacated. In verifying the intruder's identity, the system can use previously stored personnel records to ask as many questions as required (e.g., family members, address information, social security number, dates of employment, etc.).

FIG. 16 illustrates a couple of the ways in which the interrogation aspects of the invention can be performed. It will be appreciated that there are other obvious variants that can perform the same functions, depending upon system configuration, and that such elements can also be included in a local system (e.g., systems 605 or 607 of FIG. 6). The questioning by the system is preferably performed using a voice synthesizer resident on an application server (e.g., server 1609). Delivery of the synthesized voice can either use on-site speakers 1625 or use speakers 1627 co-located with, or more preferably internal to, cameras 1608. Preferably the potential intruder is allowed to vocally respond to the questions, thus allowing the system to analyze the voice using either voice recognition software or voice analysis software (to determine the possible mental state of the speaker) or both. In this embodiment the responses are either received by individual microphones 1629 or microphones 1631 co-located with, or more preferably internal to, cameras 1608. Although not preferred, responses can also be given on a keyboard/touchpad 1633.

Supplementation of Roving Security with Surveillance and Interrogation System

Operators of some premises, for example industrial sites, often require the use of roving security personnel, regardless of the level of surveillance afforded by cameras, alarm systems, etc. Typically such a system is implemented by providing each roving security person with a key that they use at a series of key boxes, the key boxes registering the time when the security person inserted their key in the key box, and thus passed by that particular key box location. One problem associated with such key box procedures is that the system does not realize if the security guard has been replaced (e.g., security guard sends a replacement, intruder replaces the guard, etc.).

The present system can be used to supplement a system that uses roving security personnel by replacing the key/key box combination with the video acquisition and analysis capabilities of the invention. In particular, the system can be set-up using the geochronshape rules to monitor a certain camera's field of view or field of view zone at specific times on particular days (e.g., 11 pm, 2 am, and 5 am everyday) for a particular image (e.g., a particular security guard). If the previously identified guard was not observed at the given times/days, or within a predetermined window of time, the notification feature could be used to notify previously identified parties (e.g., head of security, police, etc.).

In addition to insuring that the correct person is making the security rounds at the predetermined times, the system could also be set-up to ask one or more questions of the roving guard using interrogation systems such as those described above. The purpose of the questions could be to ascertain whether or not the guard was there of their own volition or under force by an intruder (e.g., using code words), to determine the conditions of the guard (e.g., sober, drunk) using response times, speech analysis, etc., or for other purposes. Given the ease by which the system can be updated, the identity of replacement guards could be easily and quickly input into the system. Furthermore using the interrogation techniques described above, even if the replacement guard had not been properly input into the system, the system could still automatically validate the replacement, for example by determining that the replacement was on an approved list of replacements and their identity was confirmed.

The use of infrared (IR) sensors, either as a supplement to the video cameras or as a replacement, could also be used to verify identity using IR signatures. Additionally IR emitters, for example with special emission frequencies or patterns, could be used for identity verification.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. A method of storing and accessing surveillance camera data, the method comprising the steps of:
capturing video data from at least one surveillance camera located at a first user site;
storing said video data on a first user data storage device located at said first user site, wherein said first user data storage device is coupled to a first user server system located at said first user site;
generating metadata that corresponds to said video data, wherein said metadata generating step is performed by said first user server system;
storing said metadata that corresponds to said video data on said first user data storage device;
transmitting said metadata that corresponds to said video data to a remotely located third party site via an Internet network, wherein said metadata transmitting step is performed automatically by said first user server system based on a predefined set of metadata transmission parameters;
storing said metadata that corresponds to said video data on a third party data storage device located at said remotely located third party site, wherein said third party data storage device is coupled to and controlled by a third party server system located at said remotely located third party site;
transmitting at least a portion of said video data from said first user site to said third party server system via said Internet network, wherein said video data transmitting step is performed automatically by said first user server system based on a predefined set of video data transmission parameters;
storing said portion of said video data on said third party data storage device; and
providing access to said metadata and said portion of said video data stored on said third party data storage device to a validated party accessing said third party server system via a secondary computer system coupled to said third party server system by said Internet network, wherein said secondary computer system is remotely located from said first user server system and from said third party server system, and wherein said validated party is validated by said third party server system.

2. The method of claim 1, further comprising the step of applying configuration instructions to a first user firewall corresponding to said first user server system, wherein said first user firewall configuration instructions prevent said first user firewall from accepting inbound connections from said secondary computer system.

3. The method of claim 1, further comprising the step of requesting a first user server operating system update from said third party server system and downloading said first user server operating system update from said third party server system, wherein said requesting and downloading steps are performed by said first user server system.

4. The method of claim 1, further comprising the steps of requesting a first user server application software update from said third party server system and downloading said first user server application software update from said third party server system, wherein said requesting and downloading steps are performed by said first user server system.

5. The method of claim 1, further comprising the step of requesting a first user server configuration update from said third party server system and downloading said first user server configuration update from said third party server system, wherein said requesting and downloading steps are performed by said first user server system.

6. The method of claim 1, further comprising the steps of:
inputting surveillance camera operational parameters and video data transmission parameters and video data storage parameters into said third party server system; and
downloading said surveillance camera operational parameters and said video data transmission parameters and said video data storage parameters from said third party server system to said first user server system.

7. The method of claim 6, wherein said inputting step is performed by said validated party.

8. The method of claim 1, further comprising the step of compressing said portion of said video data prior to performing said step of transmitting said portion of said video data to said third party server system, wherein said compressing step is performed by said first user server system.

9. The method of claim 1, further comprising the step of filtering said video data prior to performing said step of transmitting said portion of said video data to said third party server system, wherein said filtering step is performed by said first user server system.

10. The method of claim 1, further comprising the step of augmenting said video data prior to performing said step of transmitting said portion of said video data to said third party server system, wherein said augmenting step is performed by said first user server system.

11. The method of claim 1, further comprising the step of prioritizing said video data prior to performing said step of transmitting said portion of said video data to said third party server system, wherein said prioritizing step is performed by said first user server system.

12. The method of claim 1, wherein said at least one surveillance camera is one of a plurality of surveillance cameras located at said first user site, the method further comprising the step of assigning each of said plurality of surveillance cameras into one of two camera groups, wherein said first camera group is comprised of traffic cameras capturing low priority video data and wherein said second camera group is comprised of security cameras capturing high priority video data, wherein said portion of said video data transmitted from said first user server system to said third party server system is from a surveillance camera assigned to said second camera group, and wherein said method further comprises the steps of storing video data from said first camera group on said first user data storage device located at said first user site and only performing the step of transmitting video data from said first camera group to said third party server system via said Internet network after receiving a request from said third party server system to transmit said first camera group video data.

13. The method of claim 1, further comprising the step of varying video data transmission parameters in response to varying first user server system link bandwidth variations.

14. The method of claim 1, further comprising the step of buffering said video data on said first user data storage device for a preset time period prior to performing said video data transmitting step.

15. The method of claim 1, further comprising the step of transmitting a query from said first user server system to said third party server system in accordance with a predefined schedule.

16. The method of claim 15, further comprising the step of performing a first user system self-check prior to said query transmitting step, wherein said query includes results of said first user system self-check.

17. The method of claim 15, further comprising the step of transmitting an alert message in accordance with a set of preconfigured alert message instructions, wherein said alert message transmitting step is performed by said third party server system if said query is not received in accordance with said predefined schedule.

18. The method of claim 15, further comprising the step of transmitting an alert message in accordance with a set of preconfigured alert message instructions, wherein said alert message transmitting step is performed by said third party server system if said query is not received within a preset time period.

19. The method of claim 15, wherein said query transmitting step further comprises the step of requesting available software and system configuration updates from said third party server system.

20. The method of claim 15, wherein said query transmitting step further comprises the step of transmitting a password, wherein said method further comprises the steps of determining whether said password is valid or invalid, and accepting said query from said first user server system only after said password is determined to be valid, wherein said determining and accepting steps are performed by said third party server system.
